(19) United States
(12) Patent Application Publication
(10) Pub. No.: US 2025/0092204 A1
(43) Pub. Date: Mar. 20, 2025

(54) METHOD FOR PREPARING VINYL TERMINATED POLYMER BY RAPIDLY PYROLYZING POLYOLEFIN WITH LASER

(71) Applicant: SOUTH CHINA UNIVERSITY OF TECHNOLOGY, Guangzhou (CN)

(72) Inventors: Guangjian HE, Guangzhou (CN); Lun CHEN, Guangzhou (CN); Haoqin ZHANG, Guangzhou (CN); Xianwu CAO, Guangzhou (CN)

(73) Assignee: SOUTH CHINA UNIVERSITY OF TECHNOLOGY, Guangzhou (CN)

(21) Appl. No.: 18/963,720

(22) Filed: Nov. 28, 2024

Related U.S. Application Data
(63) Continuation of application No. PCT/CN2023/136099, filed on Dec. 4, 2023.

(30) Foreign Application Priority Data
Aug. 3, 2023 (CN) 202310972419.2

(51) Int. Cl. C08J 3/28

(52) U.S. Cl. CPC C08J 3/28

(57) ABSTRACT

The present invention belongs to the field of resource utilization of waste plastics, and particularly provides a method for preparing a vinyl terminated polymer by rapidly pyrolyzing polyolefin with a laser. The preparation method includes the following steps: first, adding a light absorber with a certain concentration into polyolefin as a raw material through a melt mixing process; then initiating high-temperature decomposition of polyolefin through laser irradiation under a protective effect of an inert gas; and condensing and collecting a decomposed product to obtain the vinyl terminated polymer.

### CROSS-REFERENCE TO RELATED APPLICATION

This application is a continuation of international application of PCT application serial no. PCT/CN2023/136099, filed on Dec. 4, 2023, which claims the priority benefit of China application no. 202310972419.2, filed on Aug. 3, 2023. The entirety of each of the above-mentioned patent applications is hereby incorporated by reference herein and made a part of this specification.

### TECHNICAL FIELD

The present invention belongs to the field of recovery and resource utilization of waste plastics, and particularly relates to a method for preparing a vinyl terminated polymer by rapidly pyrolyzing polyolefin with a laser.

### BACKGROUND

Plastics play an indispensable role in modern society, but their short service lives and increasing usage requirements induce an extreme imbalance between production and recovery. Particularly mass abandonment of disposably used plastics such as packaging materials, mulching films and plastic bags poses severe pollution to the natural environment and a great consumption of non-renewable resources. Polyolefins such as polyethylene, polypropylene and polystyrene constitute a large proportion in all plastics in terms of production, use, and discard rate, and the produced plastic wastes pose a severe challenge to recovery. Major treatment means for disposably used waste plastics mainly include landfilling, incineration, degraded use and the like, but these treatment means cannot realize efficient resource utilization and is likely to cause secondary pollution. Therefore, it has no time to delay development of green and efficient chemical recovery techniques to alleviate the environmental and resource pressures generated by waste plastics.

In terms of chemically inertia polyolefins, it is short of appropriate solvents for chemical recovery, so that it is hard to achieve efficient and highly selective decomposition and recycling. Pyrolysis is a universal and effective means for converting waste polyolefins into products with high additional value. Conventional pyrolysis is a thermal chemical process where polyolefin macromolecules are decomposed into a mixture of gaseous and liquid hydrocarbons and coke in a high-temperature anaerobic condition (usually higher than 500° C.). However, due to slow heating rate and limitation by heat and mass transfer, conventional pyrolysis features low efficiency and high energy consumption, and product distribution is always complex. To improve the selectivity of the products, it is reported that a two-step pyrolysis route is provided. Artetxe et al (Artetxe. M, Lopez. G, Elordi. G, Amutio. M, Bilbao. M, Olazar. M. Production of Light Olefins from Polyethylene in a Two-Step Process: Pyrolysis in a Conical Spouted Bed and Downstream High-Temperature Thermal Cracking [J]. Industrial & Engineer chemistry research, 2021, 51, 13915-13923) realized selective production of light olefins by thermally cracking high density polyethylene by a two-step process. First, virgin plastic was fed into a 500° C. conical spray bed reactor (CSBR) to obtain wax (93%) with a high yield, and then the wax generated in the first step was cracked in a 900° C. quartz reactor. In the second step, short residence time (0.016-0.032 s) was set, and the yield of the obtained light olefins (C2-C4) reached up to 77 wt %. However, massive energy input and relatively complex process flow limit the expanded development of this technology. In a pyrolysis process, adding catalyst can reduce reaction temperature and improve product selectivity. However, the cost and service of the catalyst put forward a higher requirement on the pyrolytic reaction, and catalytic pyrolysis is harder for treating highly polluted polyolefin wastes.

It is reported that novel heating techniques are adopted in pyrolysis treatment of polyolefins, for example, microwave heating, infrared heating, and pulsed electric heating. Jie et al (Jie X, Li W, Slocombe D, Gao Y, Banerjee I, Gonzalez-Cortes S, Yao B, AlMergen H, Alshihri S, Dilworth J, Thomas J, Xiao T, Edwards P. Microwave-initiated catalytic deconstruction of plastic waste into hydrogen and high-value carbons [J]. Nature catalysis, 2020 (3) (11), 902-912) used microwaves together with FeAlOX to initiate the catalytic deconstruction of waste polyolefins to generate hydrogen and carbon materials with high value. This method is high in reaction rate, and high value conversion of the waste plastics can be realized within 30-90 s. The output of hydrogen reaches up to 55.6 mmol/g_{plastic} (the concentration is −90 vol %), and more than 92% in composition of residual carbon is carbon nanotubes. A US202110588868.8 disclosed a pyrolytic and catalytic pyrolytic method by rapidly heating waste plastics with infrared rays. This method not only solves the problems of low heating rate, uneven heating of raw materials in the existing pyrolytic techniques, but also separates the pyrolytic reaction of the plastic and the subsequent catalytic reaction to flexibly regulate the pyrolytic temperature and the catalytic pyrolytic temperature, which alleviates the deactivation rate of the catalyst caused by carbon deposition, thereby improving the quality of the pyrolysis product.

In the pyrolysis process, process conditions can be controlled to generate different types of products, and a vinyl terminated polymer can be directionally generated by regulating the temperature and the degradation time. The vinyl terminated polymer is prepared by thermal degradation, which can realize upgraded utilization of waste polyolefins. This technique is simple in process, and has potential economic value and environmental benefit. Sawaguchi et al (Sawaguchi T, Suzuki Y, Sakaki A, Saito H, Yano S, Seno M. Chemical recycling of commodity vinyl polymers: selective preparation of end-reactive oligomers by controlled thermal degradation, 2000 (49), 921-925) put forward preparation of a low molecular weight polymer with end vinyl double bonds by controllable thermal degradation of isotactic polypropylene (iPP). However, the pyrolysis scheme used is conventional external electric heating, so that the product needs to be purified, and the separation difficulty is great.

To propose a pyrolytic technique which features high efficiency, low energy consumption, high additional value of products and considerable cost is a meaningful task for upgraded recycling of plastic wastes. Due to defects of poor heat transfer efficiency, uneven temperature distribution, and long timescale of pyrolytic reaction, conventional pyrolytic techniques are difficult to avoid secondary reactions among products, resulting in complex structure distributions and separating difficulty of final products, thereby reducing the economic value of further utilization. Therefore, to develop a rapid pyrolytic technique which is not limited by heat transfer and short in residence time to prepare polymers rich in end double bonds is significant in the technical field.

### SUMMARY

To overcome defects in the existing methods, an object of the present invention is to provide a method for preparing a vinyl terminated polymer by rapidly pyrolyzing polyolefin with a laser. In the present invention, the laser is used to locally heat the polyolefins, and the method features rapid heating/cooling, even/controllable temperature, high efficiency, low energy consumption, pure product with high selectivity/additional value.

To achieve the object, the present invention is achieved by the following technical solution:

First of all, a polyolefin plastic is insensitive to light in an infrared band, and is low in absorptivity. It is hard to rapidly crack the polyolefin plastic by irradiative heating by directly using an infrared laser. In the present invention, a light absorber with a certain concentration is incorporated into the polyolefin to improve the absorption coefficient of the polyolefin material on laser energy. The polyolefin raw material in the irradiated area can efficiently absorb the laser energy and convert the same into heat energy, causing the polyolefin raw material to be rapidly heated with very short time and thermally cracked, thereby effectively improving the utilization efficiency of the energy.

Second, the polyolefin raw material is only heated on the surface of the material in the laser irradiated area, with the temperatures in the non-irradiated area and the environment remaining unchanged. The reaction of thermally cracking the polyolefin with the laser only occurs in a high-temperature area irradiated, and the polyolefin material is gradually decomposed by rapidly moving a laser spot.

Furthermore, the irradiated raw material is cracked in the high-temperature area, and the cracked product is erupted, escapes in the form of steam, leaves the laser irradiated surface, and is rapidly separated from the high-temperature area along with a purging gas flow for rapid cooling. The rapid reduction of the temperature of the pyrolysis product can effectively prevent secondary reactions, which contributes to remaining the end vinyl structure generated by the cracking reaction, thereby effectively enhancing the product selectivity.

Finally, the pyrolysis product and a purging gas enter a condensation and collection device. Part of products in forms of solids and liquids are collected in the condensation device, and the gas which cannot be condensed enters a gas collection device.

A method for preparing a vinyl terminated polymer by pyrolyzing polyolefin with a laser includes the following steps:
(1) adding a light absorber with a certain concentration into a polyolefin plastic as a raw material through a melt mixing process;
(2) pressing the polyolefin raw material mixed with the light absorber into a polyolefin sheet with a certain thickness by hot pressing;
(3) placing the polyolefin sheet in a laser pyrolytic reaction device, and initiating rapid pyrolysis of polyolefin through laser irradiation under a protective effect of an inert gas to obtain a decomposed product; and
(4) feeding the decomposed product along with the inert gas into a condensation and collection device, and condensing and collecting to obtain the vinyl terminated polymer.

Preferably, in the step (1), the polyolefin plastic is one of or a mixture of several of high density polyethylene HDPE, low density polyethylene LDPE, polypropylene PP, and polystyrene PS.

Preferably, in the step (1), an extruder or an internal mixer is used in the mixing process, and polyolefin and the light absorber are mixed uniformly in the melt mixing process.

Preferably, in the step (1), the used light absorber is a thermally stable black inorganic material and is not decomposed under the action of laser irradiation; and the light absorber is, for example, carbon black, graphite, graphene, carbon nanotube, ferroferric oxide, copper oxide, or manganese dioxide, more preferably carbon black powder.

Preferably, in the step (1), a mass percentage concentration of the light absorber is 0.01-10.0%.

Preferably, in the step (2), in the hot pressing process, the raw material is pressed to a 0.1-5.0 mm thick sheet/plate in a range of 150-250° C.

Preferably, in the step (3), the inert gas is one of nitrogen, argon or helium.

Preferably, in the step (3), a used laser device is an infrared laser device which can converts light energy into heat energy through a light absorbing medium.

Preferably, in the step (3), the laser pyrolytic reaction device is a quartz glass cylinder provided with an inert gas inlet and a pyrolysis product outlet, a diameter of the cylinder is 30-500 mm, a front end of the quartz glass cylinder is connected to an inert gas purging device, a back end of the quartz glass cylinder is connected to the condensation and collection device, and the polyolefin sheet/plate mixed with the light absorber is placed inside the quartz glass cylinder.

Preferably, after the polyolefin sheet/plate containing the light absorber is placed into the laser pyrolysis reactor, the inert gas is introduced into the reactor; after air is exhausted, the laser device is started and the inert gas is kept flowing; the laser penetrates through the quartz glass and irradiates the polyolefin sheet/plate mixed with the light absorber within the cylinder to initiate rapid pyrolysis of polyolefin and generate pyrolysis product steam; and the product steam enters the condensation and collection device through a conduit.

Preferably, movement of a laser spot is achieved by controlling a galvanometer to rotate, a scanning rate of the laser spot is not less than 3 mm/s, and more preferably, the scanning rate of the laser spot is 5-15 mm/s.

Preferably, power of the used laser is 10-1000 W, and more preferably, the power of the laser is 100 W.

Preferably, in the step (4), a temperature of the condensation and collection device is set between −30-30° C., and the pyrolysis product enters a cooling device along with the inert gas for cooling, and is collected in the cooling device.

The preparation method and prepared product in the present invention have the following advantages and beneficial effects:

1. By means of laser heating and movement of the spot, rapid heating/cooling and continuous pyrolysis of the polyolefin material in a limited area can be achieved.

2. By adding the light absorber, the light absorption efficiency of the polyolefin material is improved; the photothermal conversion occurs in the irradiated area of the plastic, without heat transfer resistance and temperature gradient limitation; by controlling the concentration of the light absorber and laser parameters, the pyrolysis temperature and the pyrolysis time can be regulated precisely.

3. The controllable pyrolysis process of the polyolefin material is achieved by means of relatively high pyrolysis temperature and extremely short pyrolysis time; rapid heating of the raw material and rapid cooling of the product greatly reduce secondary reactions; and the pyrolytic reaction product contains a high content of end vinyl structures.

4. The laser in the present invention is directly acted to the raw material, and heat of laser conversion is nearly used for cracking of the plastic without an external heat dissipation process, so that the energy consumption in the pyrolysis process can be greatly reduced, and the energy utilization ratio is high.

5. The uncleaned polyolefin material with impurities can be treated, without cleaning and classifying the polyolefins in advance, so that the pre-treatment cost of the waste plastics is greatly lowered.

6. The pyrolysis device and pyrolysis process in the present invention are simple, the pyrolysis product escapes from the reaction area in form of steam, and the light absorber and the impurities in the raw material are remained in the raw material, so that it is easy to separate the product. The quality of the inertia light absorber is not changed and can be recycled.

### BRIEF DESCRIPTION OF THE DRAWINGS

FIG. 1 is a schematic diagram of a device connection for preparing a vinyl terminated polymer by pyrolyzing polyolefin with a laser in the present invention;

FIG. 2 is a comparison diagram of Fourier Transform Infrared Spectroscopy (FTIR) between solid products prepared by pyrolyzing HDPE in Embodiment 1 and Embodiments 4-11 of the present invention and a raw material;

FIG. 3 is a nuclear magnetic spectrogram (NMR) of the solid products prepared by pyrolyzing HDPE in the Embodiment 1 and the Embodiments 4-11 of the present invention;

FIG. 4 is a comparison diagram of Fourier Transform Infrared Spectroscopy (FTIR) between solid products prepared by pyrolyzing LDPE/PP in the Embodiments 2-3 of the present invention and raw materials;

FIG. 5 is a nuclear magnetic spectrogram (NMR) of the solid product prepared by pyrolyzing LDPE in the Embodiment 2 of the present invention;

FIG. 6 is a nuclear magnetic spectrogram (NMR) of the solid product prepared by pyrolyzing PP in the Embodiment 3 of the present invention;

FIG. 7A and FIG. 7B are scanning electron microscopy (SEM) of carbon black after and before a pyrolytic reaction in the Embodiment 1 of the present invention; and

FIG. 8 is a Raman spectrogram of the carbon black after and before the pyrolytic reaction in the Embodiment 1 of the present invention.

### DETAILED DESCRIPTION OF THE EMBODIMENTS

The present invention will be further described in detail below in combination with drawings and embodiments. It should be understood that these drawings and embodiments are merely illustrative of the present invention and are not intended to limit the scope of the present invention. Process parameters not particularly specified can be performed conventionally. The raw materials and reagents not indicated by manufacturers are conventional products which can be purchased on the market.

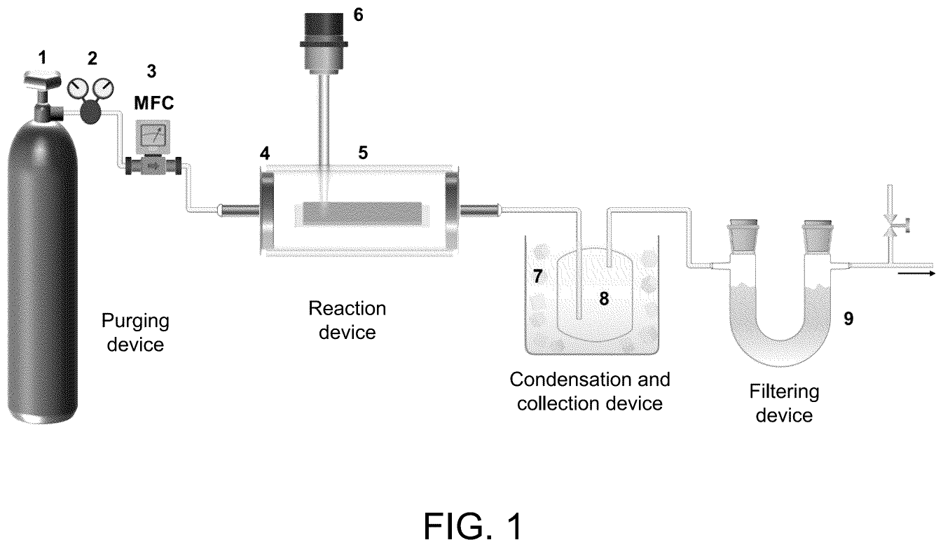

FIG. 1 is a schematic structural diagram of a laser pyrolytic reaction device used in the present invention, including an inert gas pursing device, a reaction device, a condensation and collection device, and a filtering device. In FIG. 1, there are the following components: 1, inert gas storage tank; 2, flow pressure gage; 3, flowmeter; 4, flange; 5, quartz glass cylinder; 6, laser device; 7, condenser; 8, sample collector; and 9, filter; the inert gas storage tank 1 is connected to the flange 4 at an inlet of the quartz glass cylinder 5 through a pipeline, and the flow pressure gage 2 and the flowmeter 3 are connected to the pipeline between the inert gas storage tank 1 and the quartz glass cylinder 5; the laser device 6 is arranged outside the quartz glass cylinder 5; and the flange 4 at the outlet of the quartz glass cylinder 5 is connected to the collector 8 in the condenser 7, and the collector 8 is connected to the filter 9.

The laser pyrolytic reaction devices in the following Embodiments all use the above structure.

### Embodiment 1

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 2

1) by taking 45.5 g of LDPE as a raw material, carbon black (CB) with a mass fraction of 1% was added into the raw material by means of a melt mixing action of an internal mixer; after the two were mixed uniformly, the mixture was pressed to an LDPE/CB composite sheet with a thickness of 0.5 mm under conditions of 160° C. and 15 MPa; and
2) after the LDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 50 w, and the laser scanning rate was 5 mm/s; the laser spot irradiated on the LDPE sheet mixed with the carbon black within the glass cylinder to initiate rapid heating and pyrolysis of LDPE, and a pyrolysis product was steamed and escaped under the action of the high temperature, entered the −20° C. condensation device along with a nitrogen flow, and was condensed and collected to obtain vinyl terminated polyethylene.

### Embodiment 3

1) by taking 45 g of PP as a raw material, carbon black (CB) with a mass fraction of 1% was added into the raw material by means of a melt mixing action of an internal mixer; after the two were mixed uniformly, the mixture was pressed to an PP/CB composite sheet with a thickness of 0.5 mm under conditions of 200° C. and 15 MPa; and
2) after the PP/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 60 w, and the laser scanning rate was 5 mm/s; the laser spot irradiated on the PP sheet mixed with the carbon black within the glass cylinder to initiate rapid heating and pyrolysis of PP, and a pyrolysis product was steamed and escaped under the action of the high temperature, entered the −20° C. condensation device along with a nitrogen flow, and was condensed and collected to obtain allyl terminated polypropylene.

### Embodiment 4

1) by taking 47 g of HDPE as a raw material, graphene (G) with a mass fraction of 1% was added into the raw material by means of a melt mixing action of an internal mixer; after the two were mixed uniformly, the mixture was pressed to an HDPE/G composite sheet with a thickness of 0.5 mm under conditions of 180° C. and 15 MPa; and
2) after the HDPE/G sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 5 mm/s; the laser spot irradiated on the HDPE sheet mixed with the graphene the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 5

1) by taking 47 g of HDPE as a raw material, a carbon nanotube (CN) with a mass fraction of 1% was added into the raw material by means of a melt mixing action of an internal mixer; after the two were mixed uniformly, the mixture was pressed to an HDPE/CN composite sheet with a thickness of 0.5 mm under conditions of 180° C. and 15 MPa; and
2) after the HDPE/CN sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 5 mm/s; the laser spot irradiated on the HDPE sheet mixed with the carbon nanotube the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 6

1) by taking 47 g of HDPE as a raw material, carbon black (CB) with a mass fraction of 0.1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 7

1) by taking 47 g of HDPE as a raw material, carbon black (CB) with a mass fraction of 10% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 20 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 8

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 1064 nm, the laser spot diameter was 1.5 mm, the power of the laser was 100 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 9

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 15 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 10

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 30 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 11

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 60 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 12

1) by taking 47 g of HDPE as a raw material, carbon black (CB) with a mass fraction of 1% was added into the raw material by means of a melt mixing action of an internal mixer; after the two were mixed uniformly, the mixture was pressed to an HDPE/CB composite sheet with a thickness of 0.5 mm under conditions of 180° C. and 15 MPa; and
2) after the HDPE/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 10 w, and the laser scanning rate was 5 mm/s; the laser spot irradiated on the HDPE sheet mixed with the carbon black within the glass cylinder to initiate rapid heating and pyrolysis of HDPE, and a pyrolysis product was steamed and escaped under the action of the high temperature, entered the −20° C. condensation device along with a nitrogen flow, and was condensed and collected to obtain vinyl terminated polyethylene.

### Embodiment 13

1) by taking 47 g of an HDPE milk bottle (PSW-H) as a raw material, carbon black (CB) with a mass fraction of 1% was added into the raw material by means of a melt mixing action of an internal mixer; after the two were mixed uniformly, the mixture was pressed to a PSW-H/CB composite sheet with a thickness of 0.5 mm under conditions of 180° C. and 15 MPa; and
2) after the PSW-H/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 100 w, and the laser scanning rate was 5 mm/s; the laser spot irradiated on the PSW-H sheet mixed with the carbon black within the glass cylinder to initiate rapid heating and pyrolysis of PSW-H, and a pyrolysis product was steamed and escaped under the action of the high temperature, entered the −20° C. condensation device along with a nitrogen flow, and was condensed and collected to obtain vinyl terminated polyethylene.

### Embodiment 14

1) by taking 45.5 g of an LDPE package bag (PSW-L) as a raw material, carbon black (CB) with a mass fraction of 1% was added into the raw material by means of a melt mixing action of an internal mixer; after the two were mixed uniformly, the mixture was pressed to a PSW-L/CB composite sheet with a thickness of 0.5 mm under conditions of 160° C. and 15 MPa; and
2) after the PSW-L/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 50 w, and the laser scanning rate was 5 mm/s; the laser spot irradiated on the PSW-L sheet mixed with the carbon black within the glass cylinder to initiate rapid heating and pyrolysis of PSW-L, and a pyrolysis product was steamed and escaped under the action of the high temperature, entered the −20° C. condensation device along with a nitrogen flow, and was condensed and collected to obtain vinyl terminated polyethylene.

### Embodiment 15

1) by taking 45 g of a PP lunch box (PSW-P) as a raw material, carbon black (CB) with a mass fraction of 1% was added into the raw material by means of a melt mixing action of an internal mixer; after the two were mixed uniformly, the mixture was pressed to a PSW-P/CB composite sheet with a thickness of 0.5 mm under conditions of 200° C. and 15 MPa; and
2) after the PSW-P/CB sheet was placed in the laser pyrolytic reaction device, nitrogen was introduced into the reactor, and after the air was exhausted, the laser device was started, where laser parameters of the used laser device were as follows: the wavelength was 915 nm, the laser spot diameter was 1.5 mm, the power of the laser was 60 w, and the laser scanning rate was 5 mm/s; the laser spot irradiated on the PSW-P sheet mixed with the carbon black within the glass cylinder to initiate rapid heating and pyrolysis of PSW-P, and a pyrolysis product was steamed and escaped under the action of the high temperature, entered the −20° C. condensation device along with a nitrogen flow, and was condensed and collected to obtain vinyl terminated polyethylene polypropylene.

### Product Structure Characterization

Table 1 shows conditions of laser rapid thermal cracking and test results of yields and quality of cracked products in the above Embodiments 1-15. It can be seen from table 1 that in the experimental conditions of the present invention, the yield of the solid products of laser cracking polyolefins is 60-80%, the molecular weight is between 1000-2000 Da, and the molecular weight distribution approaches to 2 and the content of the end double bonds approaches to 100%. The test results show (Embodiments 12-15) that existence of the impurities in the raw materials have no obvious interference to the selectivity and quality of the products.

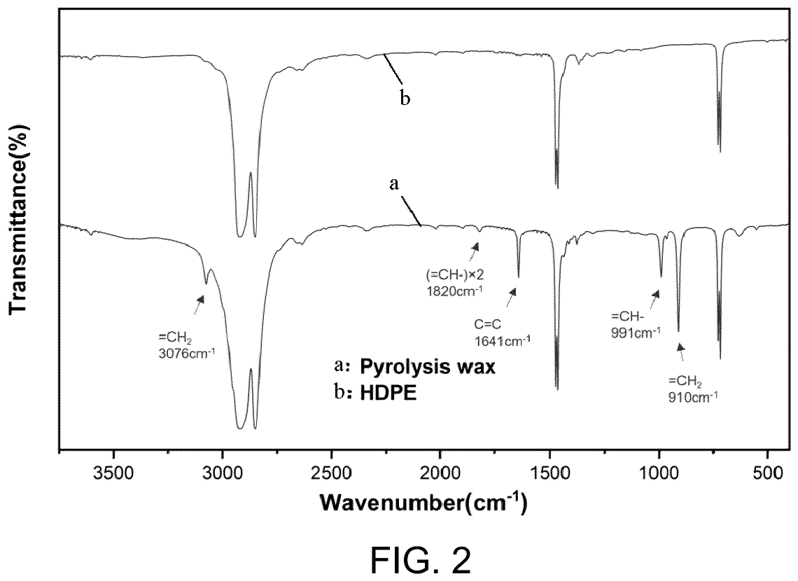

FIG. 2 is the Fourier Transform Infrared Spectroscopy of the solid products prepared in the Embodiment 1 and the Embodiments 4-11 and the raw material HDPE. It can be seen from FIG. 2 that, in the infrared spectroscopy of the solid product obtained by pyrolyzing the HDPE by the technique in the present invention, 1641 cm⁻¹ is a stretching vibration peak of a C═C bond, 3076 cm⁻¹ is a stretching vibration peak of a C—H bond in —CH═CH₂, and 991 cm⁻¹ and 910 cm⁻¹ are deformation vibration peaks of the C—H bond in —CH═CH₂. This means that a lot of end vinyl functional groups are generated in the molecular chains of the solid products prepared in the present invention.

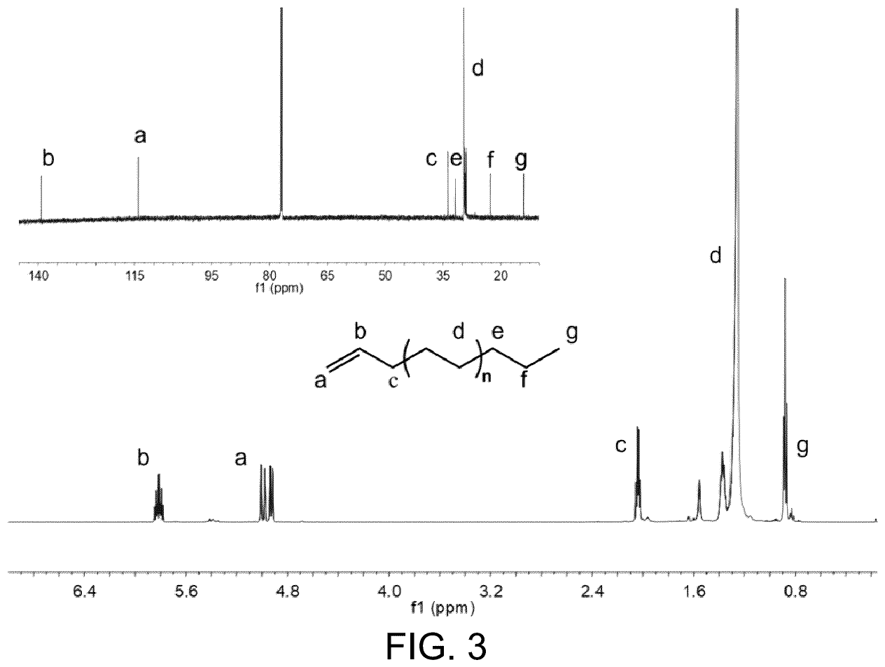

FIG. 3 is a nuclear magnetic spectrogram of the solid products prepared in the Embodiment 1 and the Embodiments 4-11. An average number of end vinyl in each molecule (f_{c}=3I₁/2I₂) is calculated through a proportional relation between an integral area I₁ of vinyl hydrogen (δ=4.90-5.02 ppm) and an integral area I₂ of methyl hydrogen (δ=0.80-0.92 ppm). According to calculation, the contents of vinyl terminated polyethylene prepared in the Embodiment 1 and the Embodiments 4-11 approach to 100%.

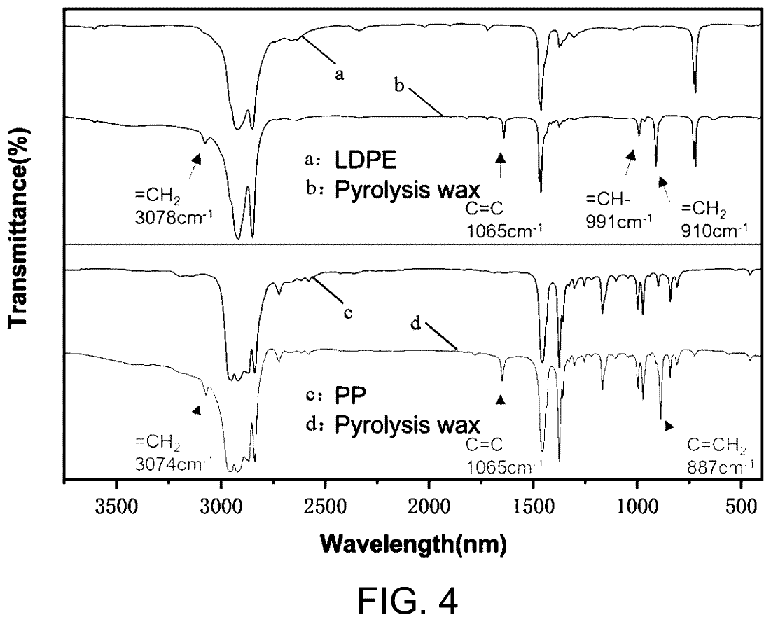

FIG. 4 is the Fourier Transform Infrared Spectroscopy of the solid products prepared in the Embodiments 2-3 and the raw material LDPE/PP. From the infrared spectrogram of the pyrolyzed solid products of LDPE, as 1641 cm⁻¹ is the stretching vibration peak of the C═C bond, 3078 cm⁻¹ is the stretching vibration peak of the C—H bond in —CH═CH₂, 991 cm⁻¹ and 910 cm⁻¹ are deformation vibration peaks of the C—H bond in —CH═CH₂, and from the infrared spectrogram of the pyrolyzed solid products of PP, as 1650 cm⁻¹ is the stretching vibration peak of the C═C bond, 3074 cm⁻¹ is the stretching vibration peak of the C—H bond in —CH═CH₂, and 887 cm⁻¹ is the deformation vibration peak of the C—H bond in —C═CH₂, it can be seen that the technology in the present invention to produce the end vinyl polymer is widely applicable to different types of polyolefin materials.

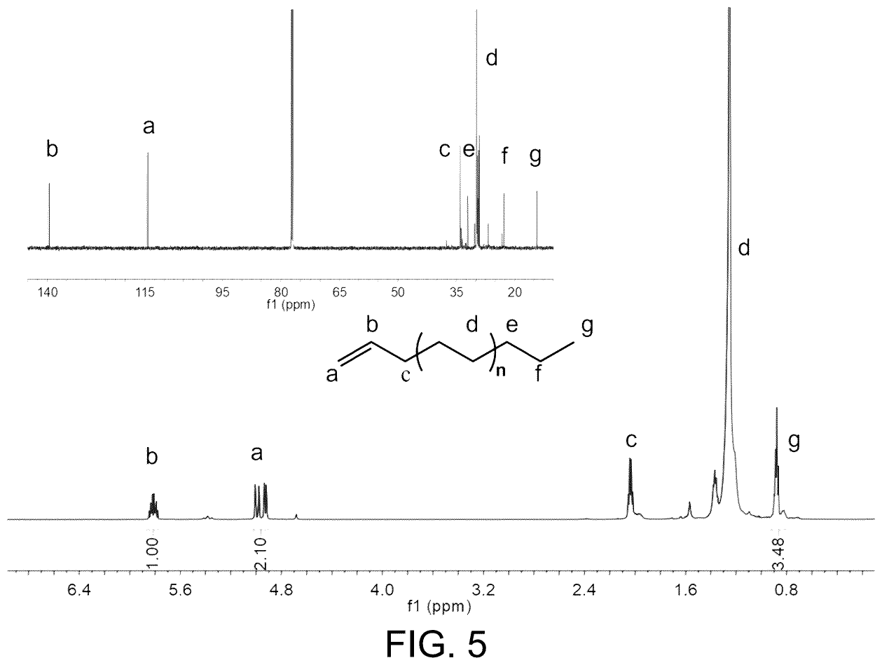

FIG. 5 is the nuclear magnetic spectrogram of the solid product prepared in the Embodiment 2. An average number of end vinyl in each molecule (f_{c}=3I₁/2I₂) is calculated through a proportional relation between an integral area I₁ of vinyl hydrogen (δ=4.90-5.02 ppm) and an integral area I₂ of methyl hydrogen (δ=0.80-0.92 ppm). According to calculation, the content of vinyl terminated polyethylene prepared in the Embodiment 9 is 90.51%, and the reason of the lower content is increase of methyl hydrogen due to the presence of side groups.

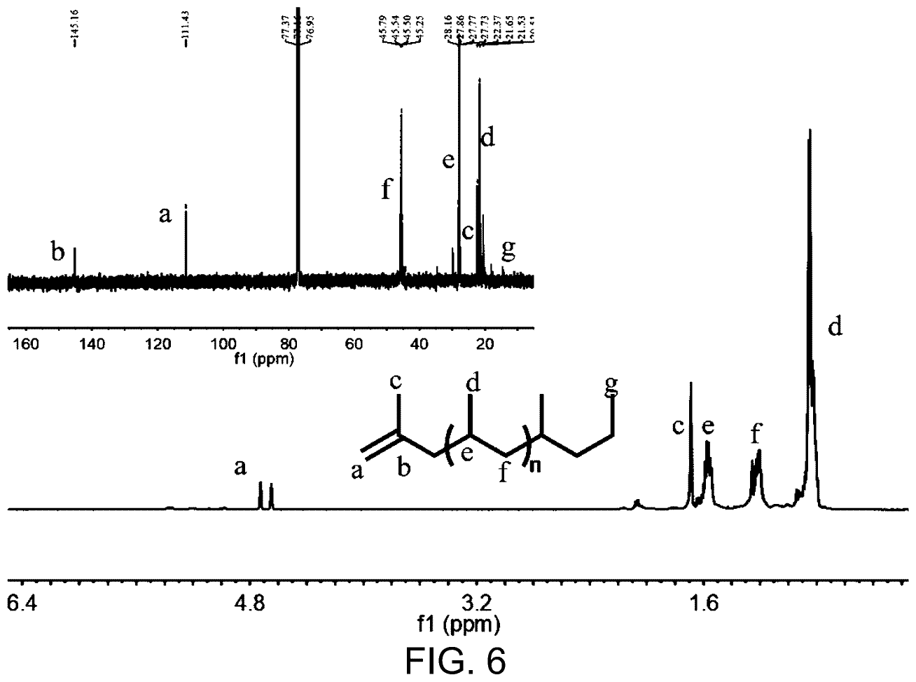

FIG. 6 is the nuclear magnetic spectrogram of the solid product prepared in the Embodiment 3. An average number of allyl in each molecule (f_{c}=2I₃/(I₃+I₄)) is calculated through a proportional relation between an integral area I₃ of methyl carbon linked to end double bond (δ=22.37 ppm) and an integral area I₄ of end methyl carbon (δ=14.59 ppm). According to calculation, the content of allyl terminated polypropylene prepared in the Embodiment 3 is 176.4%, indicating that the molecular chain of the solid product prepared by the present invention contains a lot of molecular structures with allyl at both ends.

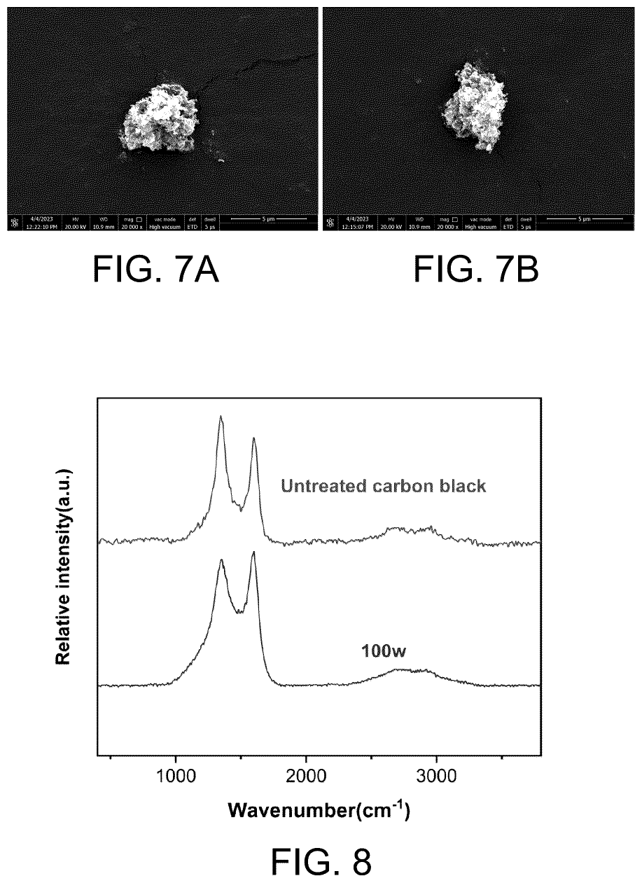

FIG. 7A, FIG. 7B, and FIG. 8 are the scanning electron microscopy (SEM) and Raman spectrogram of carbon black after and before a pyrolytic reaction in the Embodiment 1. It can be seen from the figures that after pyrolysis, the structure of the carbon black has a little change ((FIG. 7A) before pyrolysis and (FIG. 7B) after pyrolysis), the degree of graphitization is increased slightly, and the extent of the increase increases along with laser power. This indicates that the carbon black as an additive can be recycled for many times.

It can be shown in table 1 and drawings that the method provided by the present invention can achieve high value recovery of waste polyolefins, which not only can solve the environmental pollution problem, but also can prepare the vinyl terminated polymer with high value. This method greatly expands the field of resource utilization of waste plastics.

TABLE 1

| | | | | Laser parameter | | | Yield of | | Quality of cracked product | | |
|---|---|---|---|---|---|---|---|---|---|---|---|
| | | | | | | Laser | cracked product | | Molecular | Molecular | Content of |
| | Cracked | Light absorber | | Laser | Laser | scanning | Gas | Solid | weight | weight | end double |
| | raw | | Content | wavelength | power | rate | product | product | (Mw) | distribution | bonds f_{c} |
| Test item | material | Type | (wt %) | (nm) | (W) | (mm/s) | (wt %) | (wt %) | (g/mol) | (PD) | (%) |
| Embodiment 1 | HDPE | Carbon | 1 | 915 | 100 | 5 | 24.90 | 75.10 | 1284 | 1.650 | 113.0 |
| | | black | | | | | | | | | |
| Embodiment 2 | LDPE | Carbon | 1 | 915 | 50 | 5 | 22.44 | 77.56 | 1554 | 1.980 | 90.51 |
| | | black | | | | | | | | | |
| Embodiment 3 | PP | Carbon | 1 | 915 | 60 | 5 | 28.96 | 71.04 | 1392 | 2.162 | 176.4 |
| | | black | | | | | | | | | |
| Embodiment 4 | HDPE | Graphene | 1 | 915 | 100 | 5 | 28.56 | 71.64 | 1322 | 1.989 | 107.5 |
| Embodiment 5 | HDPE | Carbon | 1 | 915 | 100 | 5 | 29.11 | 70.89 | 1346 | 1.887 | 102.2 |
| | | nanotube | | | | | | | | | |
| Embodiment 6 | HDPE | Carbon | 0.1 | 915 | 100 | 5 | 24.27 | 75.53 | 1792 | 2.016 | 98.92 |
| | | black | | | | | | | | | |
| Embodiment 7 | HDPE | Carbon | 10 | 915 | 20 | 5 | 22.12 | 77.88 | 1532 | 1.890 | 99.21 |
| | | black | | | | | | | | | |
| Embodiment 8 | HDPE | Carbon | 1 | 1064 | 100 | 5 | 30.23 | 69.77 | 1356 | 1.988 | 101.2 |
| | | black | | | | | | | | | |
| Embodiment 9 | HDPE | Carbon | 1 | 915 | 100 | 15 | 27.57 | 72.43 | 1942 | 1.973 | 107.6 |
| | | black | | | | | | | | | |
| Embodiment 10 | HDPE | Carbon | 1 | 915 | 100 | 30 | 21.32 | 78.68 | 1998 | 2.011 | 78.12 |
| | | black | | | | | | | | | |
| Embodiment 11 | HDPE | Carbon | 1 | 915 | 60 | 5 | 29.49 | 70.51 | 1535 | 2.0576 | 141.4 |
| | | black | | | | | | | | | |
| Embodiment 12 | HDPE | Carbon | 1 | 915 | 10 | 5 | 20.33 | 79.67 | 1762 | 1.874 | 91.94 |
| | | black | | | | | | | | | |
| Embodiment 13 | PSW-H | Carbon | 1 | 915 | 100 | 5 | 32.34 | 67.66 | 1550 | 2.0341 | 112.4 |
| | | black | | | | | | | | | |
| Embodiment 14 | PSW-L | Carbon | 1 | 915 | 50 | 5 | 33.68 | 66.32 | 1570 | 2.1624 | 77.73 |
| | | black | | | | | | | | | |
| Embodiment 15 | PSW-P | Carbon | 1 | 915 | 60 | 5 | 32.75 | 67.25 | 1442 | 1.9043 | 155.3 |
| | | black | | | | | | | | | |

The above content is merely a basic description in the concept of the patent for invention, and any equivalent transformation made according to the technical solution of the present invention shall fall within the scope of protection of the present invention.

What is claimed is:

1. A method for preparing a vinyl terminated polymer by rapidly pyrolyzing polyolefin with a laser, comprising the following steps:
(1) adding a light absorber into a polyolefin plastic through a melt mixing process to form a polyolefin raw material;
(2) pressing the polyolefin raw material containing the light absorber into a polyolefin sheet/plate through a hot pressing process;
(3) placing the polyolefin sheet/plate in a laser pyrolytic reaction device, and initiating rapid pyrolysis of polyolefin through laser irradiation under a protective effect of an inert gas, to obtain a decomposed product; and
(4) feeding the decomposed product along with the inert gas into a condensation and collection device, and condensing and collecting to obtain the vinyl terminated polymer.

2. The method for preparing a vinyl terminated polymer by rapidly pyrolyzing polyolefin with a laser according to claim 1, wherein in the step (1), the polyolefin plastic is one or more of high density polyethylene, low density polyethylene, polypropylene, and polystyrene; and
an extruder or an internal mixer is used in the melt mixing process, and the polyolefin plastic and the light absorber are mixed uniformly in the melt mixing process.

3. The method for preparing a vinyl terminated polymer by rapidly pyrolyzing polyolefin with a laser according to claim 1, wherein in the step (1), the used light absorber is a thermal-stable black inorganic material and is not decomposed under the laser irradiation; and the light absorber comprises carbon black, graphite, graphene, a carbon nanotube, ferroferric oxide, copper oxide and manganese dioxide; and
a mass percentage concentration of the light absorber is 0.01-10.0%.

4. The method for preparing a vinyl terminated polymer by rapidly pyrolyzing polyolefin with a laser according to claim 1, wherein in the step (2), in the hot pressing process, a 0.1-5.0 mm thick sheet/plate is made by pressing in a range of 150-250° C.

5. The method for preparing a vinyl terminated polymer by rapidly pyrolyzing polyolefin with laser according to claim 1, wherein in the step (3), the inert gas is one of nitrogen, argon or helium; and
a used laser device is an infrared laser device.

6. The method for preparing a vinyl terminated polymer by rapidly pyrolyzing polyolefin with a laser according to claim 1, wherein in the step (3), the laser pyrolytic reaction device is a quartz glass cylinder provided with an inert gas inlet and a pyrolysis product outlet, a diameter of the quartz glass cylinder is 30-500 mm, a front end of the quartz glass cylinder is connected to an inert gas purging device, a back end of the quartz glass cylinder is connected to the condensation and collection device, and the polyolefin sheet/plate containing the light absorber is placed inside the quartz glass cylinder.

7. The method for preparing a vinyl terminated polymer by rapidly pyrolyzing polyolefin with a laser according to claim 1, wherein after the polyolefin sheet/plate containing the light absorber is placed into the laser pyrolytic reaction device, the inert gas is introduced into the laser pyrolytic reaction device; after air is exhausted, a laser device is started and the inert gas is kept flowing; the laser penetrates through a quartz glass cylinder and irradiates the polyolefin sheet/plate containing the light absorber within the quartz glass cylinder to initiate the rapid pyrolysis of polyolefin and generate a pyrolysis product steam; and the pyrolysis product steam enters the condensation and collection device through a conduit.

8. The method for preparing a vinyl terminated polymer by rapidly pyrolyzing polyolefin with a laser according to claim 1, wherein movement of a laser spot is achieved by controlling a galvanometer to rotate, and a scanning rate of the laser spot is not less than 3 mm/s.

9. The method for preparing a vinyl terminated polymer by rapidly pyrolyzing polyolefin with a laser according to claim 1, wherein power of the used laser is 10-1000 W.

10. The method for preparing a vinyl terminated polymer by rapidly pyrolyzing polyolefin with a laser according to claim 1, wherein in the step (4), a temperature of the condensation and collection device is set between −30-30° C., and a pyrolysis product steam enters a cooling device along with the inert gas for cooling, is condensed into a solid in the cooling device and is collected.

11. The method for preparing a vinyl terminated polymer by rapidly pyrolyzing polyolefin with a laser according to claim 6, wherein after the polyolefin sheet/plate containing the light absorber is placed into the laser pyrolytic reaction device, the inert gas is introduced into the laser pyrolytic reaction device; after air is exhausted, a laser device is started and the inert gas is kept flowing; the laser penetrates through the quartz glass cylinder and irradiates the polyolefin sheet/plate containing the light absorber within the quartz glass cylinder to initiate the rapid pyrolysis of polyolefin and generate a pyrolysis product steam; and the pyrolysis product steam enters the condensation and collection device through a conduit.

12. The method for preparing a vinyl terminated polymer by rapidly pyrolyzing polyolefin with a laser according to claim 7, wherein movement of a laser spot is achieved by controlling a galvanometer to rotate, and a scanning rate of the laser spot is not less than 3 mm/s.

13. The method for preparing a vinyl terminated polymer by rapidly pyrolyzing polyolefin with a laser according to claim 11, wherein movement of a laser spot is achieved by controlling a galvanometer to rotate, and a scanning rate of the laser spot is not less than 3 mm/s.

14. The method for preparing a vinyl terminated polymer by rapidly pyrolyzing polyolefin with a laser according to claim 7, wherein power of the used laser is 10-1000 W.

15. The method for preparing a vinyl terminated polymer by rapidly pyrolyzing polyolefin with a laser according to claim 11, wherein power of the used laser is 10-1000 W.
